(19) United States
(12) Patent Application Publication
(10) Pub. No.: US 2025/0297496 A1
(43) Pub. Date: Sep. 25, 2025

(54) VEHICLE DOOR LATCH, ASSOCIATED VEHICLE DOOR AND ASSOCIATED VEHICLE

(71) Applicant: Minebea AccessSolutions France, Alfortville (FR)

(72) Inventors: Laurent DURIEZ, Alfortville (FR); François DEBROUCKE, Alfortville (FR); Jérémy PAUMELLE, Alfortville (FR)

(73) Assignee: Minebea AccessSolutions France, Alfortville (FR)

(21) Appl. No.: 19/079,852

(22) Filed: Mar. 14, 2025

(30) Foreign Application Priority Data
Mar. 20, 2024 (EP) 24315100

(51) Int. Cl. E05B 77/04; E05B 85/26

(52) U.S. Cl. CPC E05B 77/04; E05B 85/26

(57) ABSTRACT

A vehicle door latch includes a housing having an opening, a claw having a jaw providing, in combination with the housing, a recess for receiving a striker in a closed position of the door and a tunnel for accessing the recess, the claw being arranged to rotate between a closed position wherein the tunnel is obturated by the jaw and an opened position enabling the passage of the striker through the tunnel, and a pawl to block the rotation of the claw in an intermediate position wherein the striker is restrained by the jaw in the tunnel. The jaw includes a tooth for restraining the striker in the tunnel in the intermediate position.

### TECHNICAL FIELD

The present invention relates to the field of vehicle door latches to ensures the closing of vehicle doors.

### BACKGROUND OF THE INVENTION

The present invention refers to a vehicle door latch configured for interacting with a striker attached to the vehicle body to ensure the closing of the door.

The vehicle door latches are usually associated with several states:
an opened state wherein the door is opened and the striker is located outside of the latch,
a closed state wherein the striker is located at the bottom of the recess of the latch and is blocked in the recess by a claw of the latch and wherein the door flushes with the vehicle body and,
an intermediate state wherein the striker is located on the edge of the recess and is restrained by the claw so that the door cannot be opened but is not completely closed.
   In case of a crash when the latch is in the intermediate position, the latch has to be configured for restraining the striker in order to prevent an opening of the door. In order to be able to restrain the striker, the claw has therefore to apply a force high enough. However, the force exerted by a return spring cannot be too high to enable the insertion of the striker in the recess without requiring too much effort for the user.

It is therefore an aim of the present invention to provide a vehicle door latch enabling the insertion of the striker without excessive force while reducing the risk of opening of the door in case of a crash when the door in the intermediate state.

### SUMMARY OF THE INVENTION

The present invention refers to a vehicle door latch comprising:
a housing comprising an opening,
a claw comprising a jaw providing, in combination with the housing, a recess configured for receiving a striker in a closed position of the door and an associated tunnel for accessing the recess, the claw being configured to rotate between a closed position wherein the tunnel is obturated by the jaw and an opened position enabling the passage of the striker through the tunnel,
a pawl configured to block the rotation of the claw in an intermediate position wherein the striker is restrained by the jaw in the tunnel,
   wherein the jaw comprises a tooth configured for restraining the striker in the tunnel in the intermediate position.

According to another aspect of the present invention, the claw comprises a plastic coating that provides a planar jaw in the tunnel to ease the introduction of the striker in the recess through the tunnel wherein the plastic coating is configured to be compressed by the striker in case of a crash when the striker is restrained in the intermediate position by the claw.

According to another aspect of the present invention, the plastic coating is made of a thermoplastic elastomer such as Hytrel®.

According to another aspect of the present invention, the thickness of the plastic coating is at least equal to the tooth height, for example comprised between 1 and 1.2 times the height of the tooth.

According to another aspect of the present invention, the thickness of the plastic coating is comprised between 0.5 mm and 5 mm, preferably between 0.6 mm and 0.8 mm, in particular between 0.6 mm and 1 mm.

According to another aspect of the present invention, the claw can be positioned above or under the striker.

According to another aspect of the present invention, the curvature of the tooth is similar to the curvature of the cross-section of the striker.

According to another aspect of the present invention, the latch also comprises elastic means such as a helicoidal spring to constrain the claw towards the closed position.

The present invention also refers to a vehicle door comprising a vehicle door latch as described previously.

The present invention also refers to a vehicle comprising a striker and a vehicle door as described previously.

### BRIEF DESCRIPTION OF THE DRAWINGS

FIG. 1 is a perspective and cut view of a part of a door latch according to an embodiment of the present invention;

FIG. 2 is a side and cut view of a portion of a claw of the latch of FIG. 1;

FIG. 3 is a perspective and cut view of a part of the door latch of FIG. 1 and a striker;

FIG. 4 is a side and cut view of a portion of a part of the door latch of FIG. 1 and a striker;

FIG. 5 is a side and cut view of a portion of a part of the door latch of FIG. 1 and a striker after compression of the coating;

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

The present invention refers to a vehicle door latch 1 used to lock the door of the vehicle. Such vehicle door latch 1 is usually arranged in a door panel and is configured to interact with a striker 3 fixed to the vehicle body next to the door.

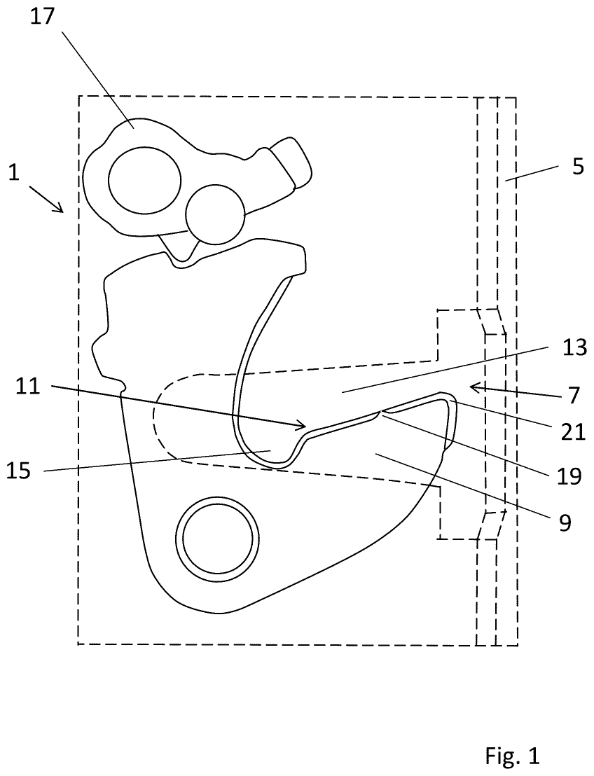

FIG. 1 represents a part of a latch 1 according to an embodiment of the present invention. The latch 1 comprises a housing 5 configured for protecting the latch mechanism. The housing 5 may be a metallic housing, for example a steel housing. The housing 5 comprises an opening 7 configured for receiving the striker 3. The housing 5 may have a parallelepipedal shape and the opening 7 may be arranged at the interface between two faces of the housing 7.

The latch 1 also comprises a claw 9 arranged in the housing 5. The claw 9 may be positioned next to the opening 7 and may protrude within the opening 7. The claw 9 comprises a jaw 11. The combination of the opening 7 of the housing 5 and the jaw 11 provides a tunnel 13 and a recess 15 arranged at the end of the tunnel 13. The recess 15 may be achieved by a material removal in an internal part of the jaw 11. The recess 15 is configured for receiving the striker 3 in a closed state of the door.

The claw 9 is configured to rotate between the closed state or closed position wherein the tunnel 13 is obturated by the jaw 11 in order to restrain the striker 3 in the recess and an opened state or opened position enabling the passage of the striker 3 through the tunnel 13. The claw 9 is configured to rotate around a shaft that can be positioned under the tunnel 13 as represented in FIG. 1, above the tunnel 13 or behind (next to) the tunnel 13.

The latch 1 also comprises a pawl 17 configured to cooperate with the claw 9 to enable or to block the rotation of the claw 9. The pawl 17 is notably configured to block the rotation of the claw 9 in an intermediate state or intermediate position wherein the striker 3 is restrained by the jaw 11 in the tunnel 13 which corresponds to the position of a door which is partially closed, that is to say, the door is not fully closed (in this state, the door panel usually does not flush with the adjacent vehicle body) but cannot be opened without acting on the inner or outer handle.

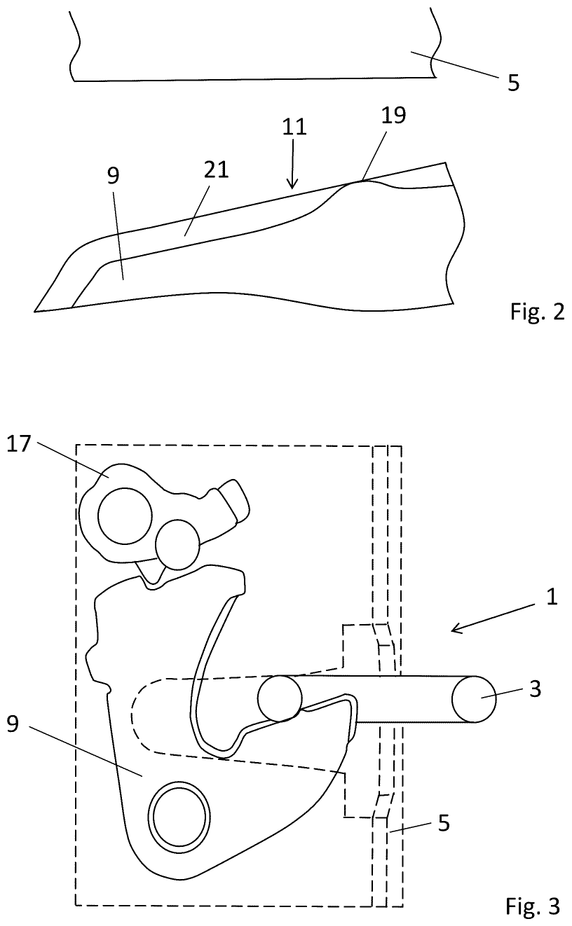

Furthermore, the jaw 11 comprises a tooth or protuberance 19 configured for restraining the striker 3 in the tunnel 13 in the intermediate position, in particular in case of a crash. FIG. 2 represents an enlarged view of a portion of the jaw 11 and the associated tooth 19. The tooth 19 allows directing the force applied by the jaw 11 on the striker 3 towards to the internal part of the tunnel 13 so that the striker 3 is restrained more efficiently with the application of a given torque. Such torque may be applied by the combination of the pawl 17 and elastic means such as a helicoidal spring configured to constrain the claw 9 towards the closed position.

The tooth 19 may be shaped so that at least its internal side (towards the recess 15) has a curved concave shape with a curvature corresponding noticeably to the radius of the cross-section of the striker 3.

The jaw 11 also comprises a plastic coating 21 such as a thermoplastic elastomer coating, for example a Hytrel® coating. The thickness of the coating 21 is at least equal to the height of the tooth 19, for example between 1 and 1.2 times the height of the tooth and is configured for recovering the tooth 19 to make a planar jaw 11. The thickness of the coating 21 may be comprised between 0.5 mm and 5 mm, preferably between 0.6 mm and 0.8 mm, in particular between 0.6 mm and 1 mm. Such thickness is reduced at the location of the tooth 19. The plastic coating 21 is configured to be compressed by the striker 3 when a force higher than a predetermined threshold is applied by the striker 3. Such predetermined threshold depends on the material of the plastic coating 21. Such compression of the plastic coating 21 by the striker 3 occurs in case of a crash when the striker 3 is in the intermediate position as represented in FIG. 3.

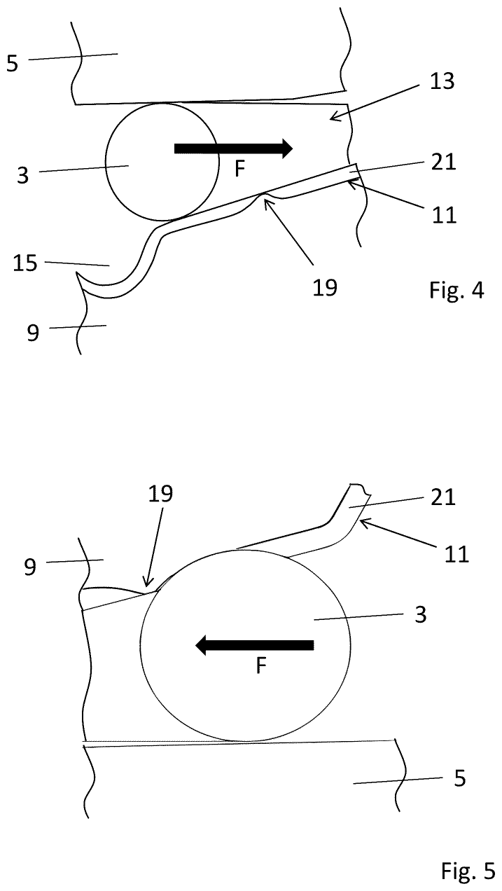

FIG. 4 represents a diagram of the striker in the intermediate position in normal functioning (not during a crash). In such normal functioning, the jaw 11 presents a flat surface enabling the insertion and the release of the striker 3. Such planar jaw also enables applying a given torque in the intermediate which may restrain the striker within the tunnel if the force applied by the striker towards the outer side of the tunnel is not too high. If this force becomes too high as in the case of a crash, the coating 21 is then compressed under the pressure of the striker 3 as represented in FIG. 5 which allows restraining the striker in the tunnel even if the force of the crash is higher than the predetermined threshold. Indeed, the compressed coating modify the shape of the jaw and makes the tooth shape 19 apparent. The shape of the tooth 19 modifies the direction of the force applied by the jaw 11 on the striker 3 and allows the jaw 11 to counter react to the force F applied by the striker 3 during the crash as represented in FIGS. 4 and 5. As the curvature of the tooth corresponds to the radius of the cross-section of the striker 3, the contact surface between the striker 3 and the jaw 11 is maximized after compression of the coating 21.

After the crash, the coating 21 needs to be replaced if the vehicle door latch 1 is reused.

The present invention also refers to a vehicle door comprising a vehicle door latch 1 as described previously and to a vehicle comprising a striker 3 and such vehicle door.

1-9. (canceled)

10. A vehicle door latch, comprising:
a housing comprising an opening;
a claw comprising a jaw providing, in combination with the housing, a recess configured to receive a striker in a closed position of the door and a tunnel to access the recess, the claw being configured to rotate between a closed position wherein the tunnel is obturated by the jaw and an opened position to enable passage of the striker through the tunnel; and
a pawl configured to block the rotation of the claw in an intermediate position wherein the striker is restrained by the jaw in the tunnel,
wherein the jaw comprises a tooth configured to restrain the striker in the tunnel in the intermediate position.

11. The vehicle door latch in accordance with claim 10, wherein the claw comprises a plastic coating that provides a planar jaw in the tunnel to ease an introduction of the striker in the recess through the tunnel wherein the plastic coating is configured to be compressed by the striker in case of a crash when the striker is restrained in the intermediate position by the claw.

12. The vehicle door latch in accordance with claim 11, wherein the plastic coating is made of a thermoplastic elastomer.

13. The vehicle door latch in accordance with claim 11, wherein a thickness of the plastic coating is at least equal to a of the tooth.

14. The vehicle door latch in accordance with claim 11, wherein a thickness of the plastic coating is between 0.5 mm and 5 mm.

15. The vehicle door latch in accordance with claim 10, wherein a curvature of the tooth is similar to a curvature of a cross-section of the striker.

16. The vehicle door latch in accordance with claim 10, further comprising elastic means to constrain the claw towards the closed position.

17. The vehicle door latch in accordance with claim 16, wherein the elastic means is a helicoidal spring.

18. A vehicle door, comprising:
the vehicle door latch according to claim 10.

19. A vehicle, comprising:
the vehicle door according to claim 18.
